(19) United States
(12) Patent Application Publication
(10) Pub. No.: US 2009/0139420 A1
(43) Pub. Date: Jun. 4, 2009

(54) Gripper for Conveying a Sheet Through a Printing Technology Machine

(75) Inventors: Henri Festa, Heidelberg (DE); Thomas Schmidt, Eppelheim (DE)

Correspondence Address: LERNER GREENBERG STEMER LLP, P O BOX 2480, HOLLYWOOD, FL, 33022-2480, US

(73) Assignee: HEIDELBERGER DRUCKMASCHINEN AG, Heidelberg (DE)

(21) Appl. No.: 12/325,440

(22) Filed: Dec. 1, 2008

(30) Foreign Application Priority Data
Nov. 29, 2007 (DE) 10 2007 057 459.4

(51) Int. Cl. B41F 21/10

(52) U.S. Cl. 101/410

(57) ABSTRACT

A gripper for conveying a sheet through a printing machine makes it possible to increase speed. The gripper includes gripper fingers with finger tips disposed at a rotary articulation or joint.

### CROSS-REFERENCE TO RELATED APPLICATIONS

This application claims the priority, under 35 U.S.C. §119, of German Patent Application DE 10 2007 057 459.4, filed Nov. 29, 2007; the prior application is herewith incorporated by reference in its entirety.

### BACKGROUND OF THE INVENTION

1. Field of the Invention

The invention relates to a gripper for conveying a sheet through a printing technology machine, including two gripper fingers on a revolving body, finger tips with gripping surfaces at respective ends of the gripper fingers, a device for cyclically pivoting the gripper fingers about an axis, and a device for cyclically opening and closing the gripper fingers.

Gripper systems each having a series of spaced-apart grippers on gripper bars are used to convey a sheet through a printing machine. The grippers each include a gripper finger, which interacts with a gripper support, or two interacting gripper fingers.

In the case of turning drums, gripper fingers are used which interact in pairs, receive a sheet at a trailing edge from an upstream storage drum and transfer it to a gripper system of a downstream impression cylinder, as in German Published, Non-Prosecuted Patent Application DE 24 14 998 A1, corresponding to U.S. Pat. No. 4,101,122. When the sheets are conveyed from the storage drum to the impression cylinder, the gripper fingers execute a cyclic pivoting movement during a revolution of the turning drum. The pivot axis of the gripper fingers is located, in the radial direction, approximately on the revolving contour or periphery of the turning drum. When a sheet is received from the storage drum, the gripper fingers pivot in over the trailing sheet edge. As the sheet is being received, the gripper surfaces on the gripper fingers are located in the sheet-running direction, which is not ideal, and that results in undesired deformation of the sheet edge. A convex configuration of the gripping surfaces is intended to compensate for the non-ideal orientation of the gripping surfaces in the transfer positions. Following transfer, the gripper fingers are pivoted, at a short time interval, through an angle of more than 180°, and high accelerating forces occur. The accelerating forces are supplied through the use of a gripper-control mechanism, with it being necessary for the mechanism members and the gripper fingers to be configured with a high level of rigidity. The installation-space conditions with respect to the drums, and the movement geometries of the gripper fingers, limit the level of rigidity which can be achieved.

### SUMMARY OF THE INVENTION

It is accordingly an object of the invention to provide a gripper for conveying a sheet through a printing technology machine, which overcomes the hereinafore-mentioned disadvantages of the heretofore-known devices of this general type and which makes it possible to increase speed.

With the foregoing and other objects in view there is provided, in accordance with the invention, a gripper for conveying a sheet through a printing technology machine. The gripper comprises two gripper fingers disposed on a revolving body, finger tips each being disposed at an end of a respective one of the gripper fingers and each having a respective gripping surface, a device for cyclically pivoting the gripper fingers about an axis, a device for cyclically opening and closing the gripper fingers, and rotary joints. The finger tips on the gripper fingers are each disposed at a respective one of the rotary joints.

Therefore, according to the invention, the finger tips of gripper fingers have an articulated construction, in which gripping surfaces on the finger tips can be moved about a joint axis which is not a pivot axis of the gripper fingers. This makes it possible to orient the gripping surfaces in such a way that undesirable deformation of the sheet edge does not occur. The gripping surfaces are located approximately in the sheet-running direction.

In accordance with another feature of the invention, the finger tips can be pivoted in such a way that their pivoting movement precedes the pivoting movement of the gripper fingers. In one embodiment, the finger tips are retained at a rotary articulation or joint, with a pivoting movement of the gripping surfaces being initiated through two connecting rods.

In accordance with a further feature of the invention, a pivot axis of gripping surfaces may be provided on a revolving crank, with the crank being located in such a way that it can be pivoted about a pivot axis of the gripper fingers. In the case of this variant, a spring may be provided in order to open the gripper fingers.

In accordance with an added feature of the invention, it is possible for gripper fingers to be displaceable relative to one another perpendicularly to their pivot axis in such a way that the gripping surfaces are oriented in the sheet-running direction. In the case of this embodiment, one of two gripper fingers, which interact in pairs, may be disposed in such a way that it can be pivoted about an axis which is spaced apart at a distance from, and parallel to, a joint pivot axis of the gripper fingers.

In accordance with a concomitant feature of the invention, the movement of the gripping surface may be coupled to the movement of the gripper fingers. A tong gripper may, in particular, be used for this purpose.

Other features which are considered as characteristic for the invention are set forth in the appended claims.

Although the invention is illustrated and described herein as embodied in a gripper for conveying a sheet through a printing technology machine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a fragmentary, diagrammatic, side-elevational view of a gripper in an angled position with gripper-finger tips which can be pivoted by a linkage mechanism;

FIG. 2 is a fragmentary, side-elevational view of the gripper in a straightened-out position with pivotable gripper tips;

FIG. 3 is a mechanism diagram for controlling the grippers according to FIGS. 1 and 2;

FIG. 4 is a fragmentary, side-elevational view of the gripper in an angled position with gripper-finger tips which can be pivoted by a crank drive;

FIG. 5 is a fragmentary, side-elevational view of the gripper in a straightened-out position with gripper-finger tips which can be pivoted by a crank drive; and

FIGS. 6-8 are fragmentary, side-elevational views of the gripper in three different pivoting positions with pivotable gripper-finger tips and a separately mounted gripper finger.

### DETAILED DESCRIPTION OF THE INVENTION

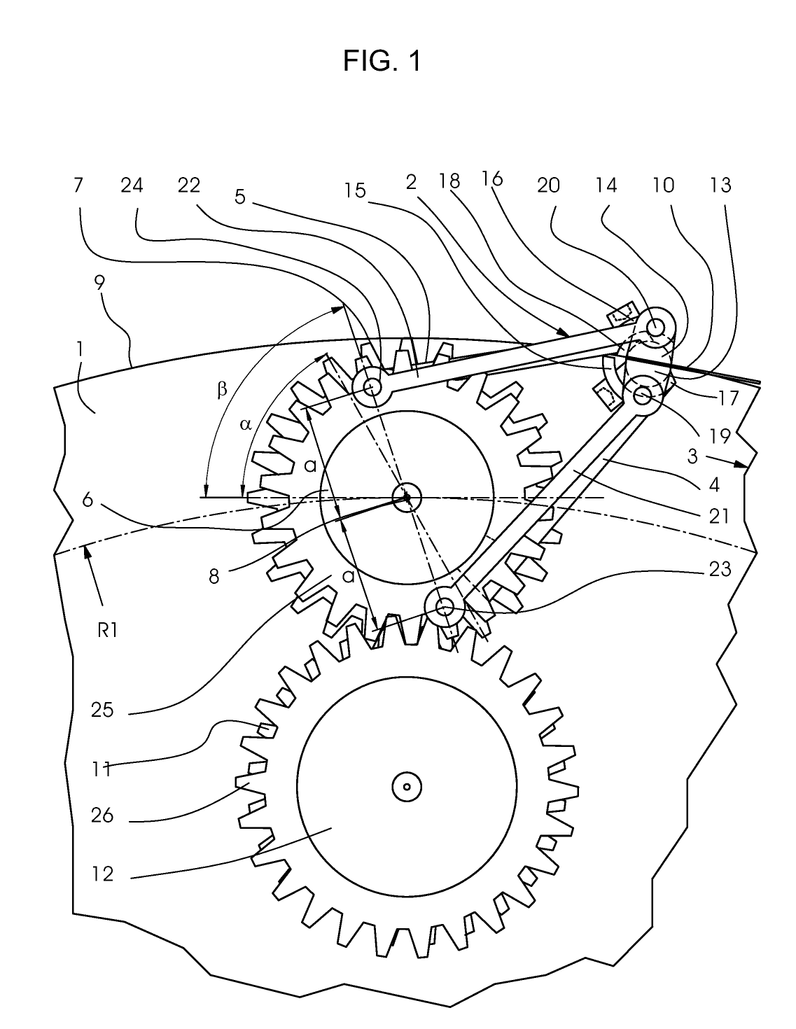

Referring now to the figures of the drawings in detail and first, particularly, to FIG. 1 thereof, there is seen a body, member or element 1 of a turning drum of a sheet-fed printing machine having a tong-gripper system 2. The turning drum is located between an upstream storage drum and a downstream impression cylinder. The turning drum is driven, in the direction of an arrow 3, synchronously with the storage drum and the impression cylinder. The tong-gripper system 2 includes a series of gripper fingers 4, 5 which interact in pairs and are spaced apart along a gripper shaft 6. The gripper fingers 4 are fixed to the gripper shaft 6. The gripper fingers 5 are coupled in each case individually or in groups to a pinion 7, which is mounted in a rotatable manner on the gripper shaft 6. The gripper shaft 6 and the pinions 7 can be pivoted about an axis 8 located parallel to the axis of rotation of the drum body 1. The axis 8 is located on a radial line R1 on the drum body 1, in which case the shaft 6 and the pinion 7 are located within a revolving contour or periphery 9 of the turning drum.

The gripper fingers 4, 5 can be opened and closed by rotating the gripper shaft 6 and the pinion 7 relative to one another. When a sheet 10 is conveyed from the storage drum to the downstream impression cylinder, the closed gripper fingers 4, 5 jointly execute a pivoting movement about the axis 8. In order to initiate this pivoting movement, the pinion 7 engages with a pinion 11, which is disposed in a rotationally fixed manner on a drive shaft 12 disposed parallel to the gripper shaft 6. There is a 1:1 transmission ratio between the pinions 7, 11.

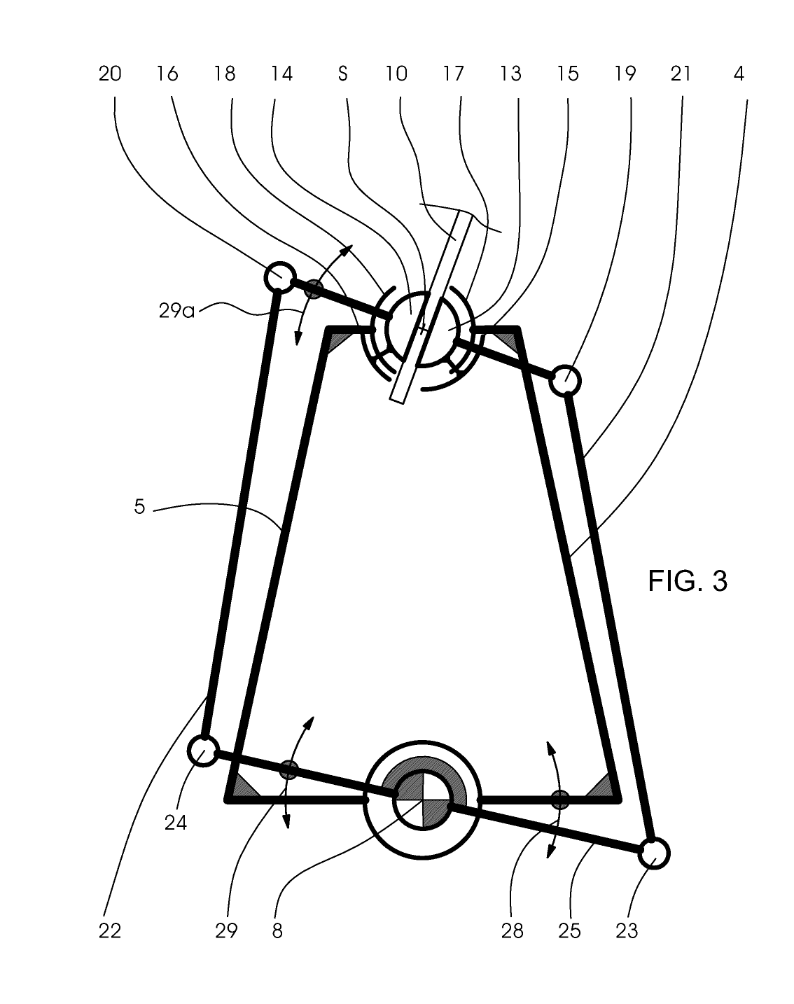

The sheet 10 is retained at the edge in finger tips 13, 14 which have planar gripping surfaces. Guide components 15, 16 retain the finger tips 13, 14 at the ends of the gripper fingers 4, 5 when the grippers are open. In the closed state of the gripper fingers 4, 5, the finger tips 13, 14 are located symmetrically relative to a joint pivot axis S (see FIG. 3), which runs parallel to the axis 8. Cylindrical half-shells 17, 18 at the ends of the gripper fingers 4, 5 form a rotary articulation or joint for the finger tips 13, 14 about the axis S. Connecting rods 21, 22 are retained on the finger tips 13, 14 at rotary articulations or joints 19, 20. The other respective ends of the connecting rods 21, 22 are retained on a pinion 25 at rotary articulations or joints 23, 24 and this pinion 25 is mounted in a rotatable manner on the gripper shaft 6. The axes of rotation of the articulations 19, 20, 23, 24 are located parallel to the axis 8. The axes of rotation of the articulations 23, 24 are spaced apart in each case by a distance a from the axis 8. The pinion 25 engages with a further pinion 26, which is seated in a rotationally fixed manner on the drive shaft 12. The pinions 26 and 25 form a transmission, in which case the rotary articulations or joints 23, 24 are pivoted further than the gripper fingers 4, 5 about the axis 8, for example in order for a sheet 10 to be received from the storage drum.

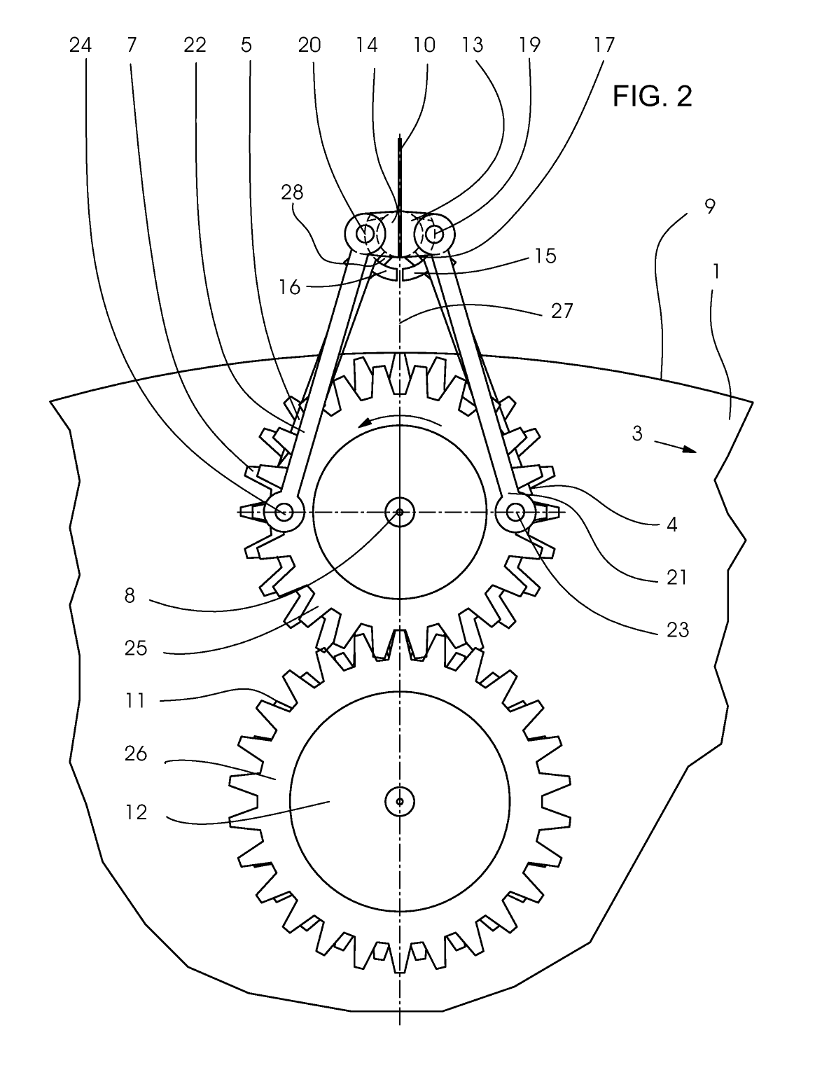

FIG. 1 shows the gripper fingers 4, 5 and the finger tips 13, 14 shortly after the trailing edge of a sheet 10 has been received from the storage drum. Starting from the straightened-out position (FIG. 2), the gripper fingers 4, 5 have been pivoted through an angle a about the axis 8, whereas the articulations 23, 24 of the connecting rods 21, 22, which control the finger tips 13, 14, have been pivoted through an angle β, where β is greater than α. In accordance with the geometry of the connecting rods 21, 22 and of the finger tips 13, 14, the planar gripping surfaces of the finger tips 13, 14 are located approximately tangentially in relation to the revolving contour 9.

FIG. 2 shows the gripper fingers 4, 5 and the finger tips 13, 14 in a straightened-out or elongated position. The planar gripping surfaces of the finger tips 13, 14 are located in a radial direction 27 of the drum body 1.

Where the following description makes use of designations which have already been introduced, these denote elements or symbols with an equivalent effect or equivalent meaning.

FIG. 3 shows a mechanism diagram for controlling the pivoting movement of the finger tips 13, 14 relative to the gripper fingers 4, 5. While the gripper fingers 4, 5 are closed and the sheet 10 is retained between the finger tips 13, 14, the gripper fingers 4, 5 jointly execute a cyclic pivoting movement 28 about the axis 8, and the axes of rotation 23, 24 of the connecting rods 21, 22, which drive the finger tips 13, 14, execute a further cyclic pivoting movement 29 about the axis 8. The finger tips 13, 14 in this case execute a pivoting movement 29a about the axis S. The pinion 25, the connecting rods 21, 22 and the finger tips 13, 14, which are pressed together by way of the gripper fingers 4, 5, are mechanism members of a 4-bar linkage mechanism having the articulations 19, 20, 23, 24. The different transmission ratios between the pinions 7, 11 and 25, 26 give rise to different characteristics of the pivoting movements 28, 29. In addition, the pivoting movement 29a is dependent on the transmission behavior of the 4-bar linkage mechanism.

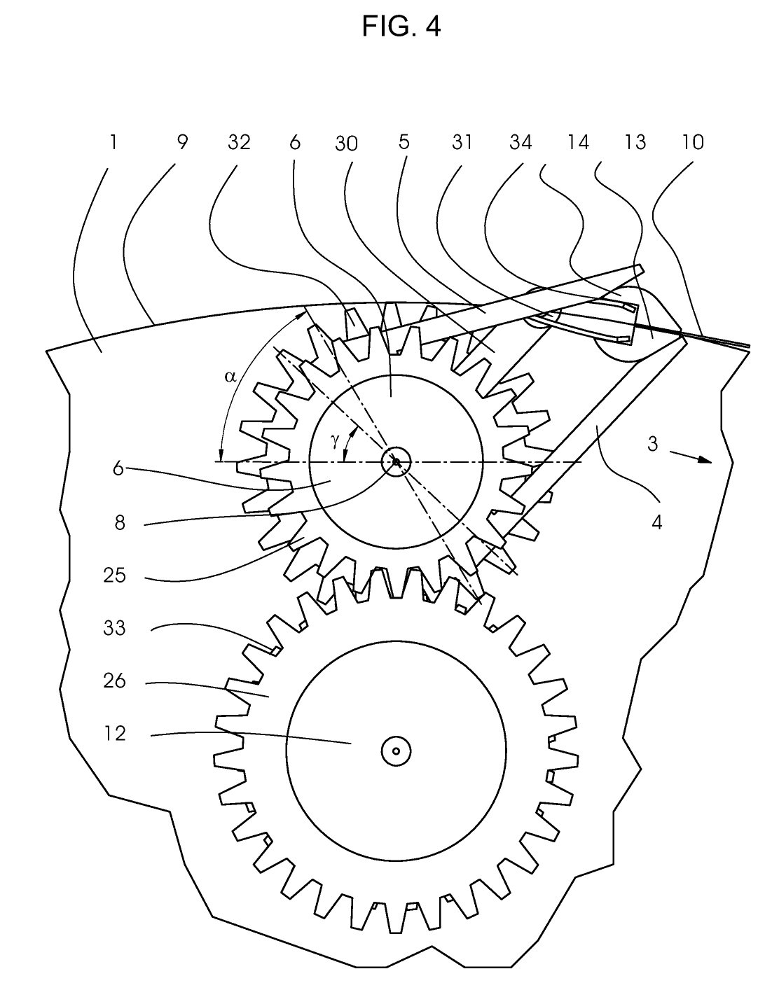

FIG. 4 shows a further variant for pivoting finger tips 13, 14 which are retained between the ends of gripper fingers 4, 5. As has been described in relation to FIGS. 1-3, the gripper fingers 4, 5 are fastened on the gripper shaft 6 and can be pivoted about a joint axis 8 through the use of the pinions 25, 26. The finger tips 13, 14 are mounted at a rotary articulation or joint 31 at one end of a crank 30. The axis of rotation of the rotary articulation or joint 31 is located parallel to the axis 8 of the gripper shaft 6. The crank 30 is connected to a pinion 32 which is disposed in a rotatable manner on the gripper shaft 6. The pinion 32 engages with a pinion 33 which, like the pinion 26, is fastened in a rotationally fixed manner on the drive shaft 12. The gripper fingers 4, 5 open in order to receive and transfer sheets. The finger tips 13, 14 in this case are retained at the ends of the gripper fingers 4, 5 by a spring 34 and are thus pivoted in relation to one another about the rotary articulation or joint 31. The transmission ratios between the pinions 25, 26 and 32, 33 are selected in such a way that, once the sheet 10 has been received from an upstream storage drum, the pivoting movement of the crank 30 follows the pivoting movement of the gripper fingers 4, 5.

FIG. 4 shows the gripper fingers 4, 5 in a pivoting position a and the crank 30 in a pivoting position γ, where γ<α. The gripping surfaces of the finger tips 13, 14 are located more or less tangentially in relation to the revolving contour or periphery 9 of the drum body 1.

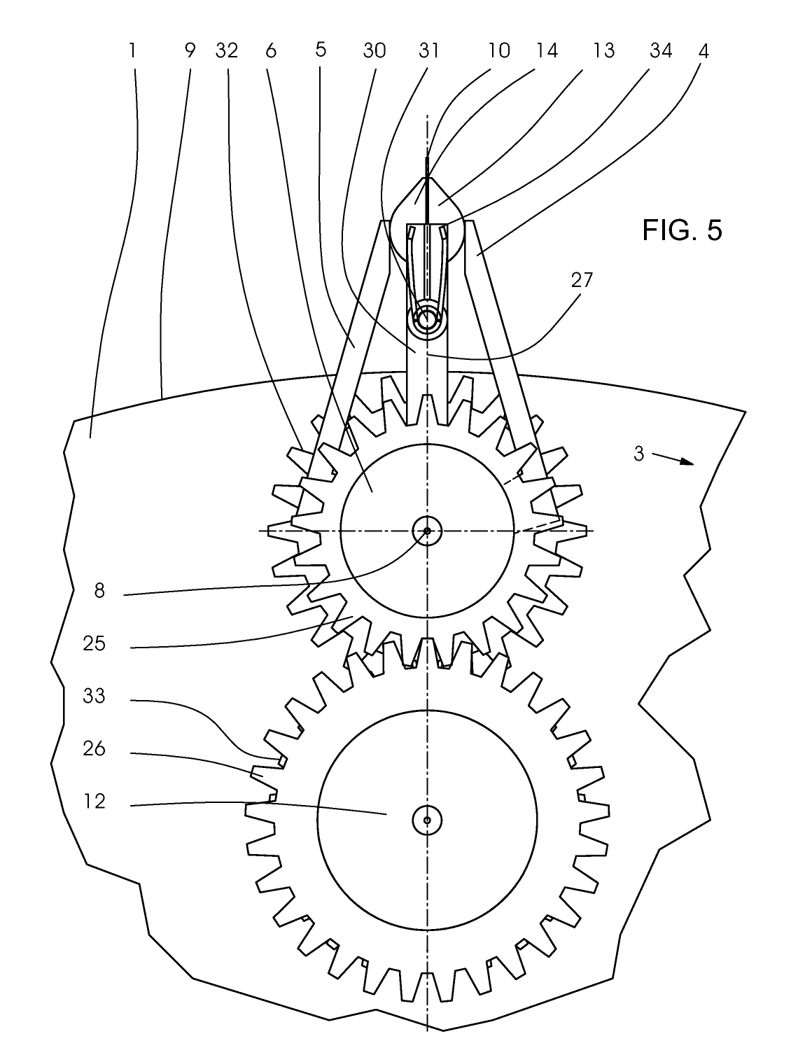

As the drum body 1 is rotated further in the direction of the arrow 3, the gripper fingers 4, 5 and the finger tips 13, 14 move into a straightened-out or elongated position, which is illustrated in FIG. 5. In the straightened-out position, the gripping surfaces of the finger tips 13, 14 and the gripper fingers 4, 5 are located symmetrically in relation to a radial line 27 of the turning drum.

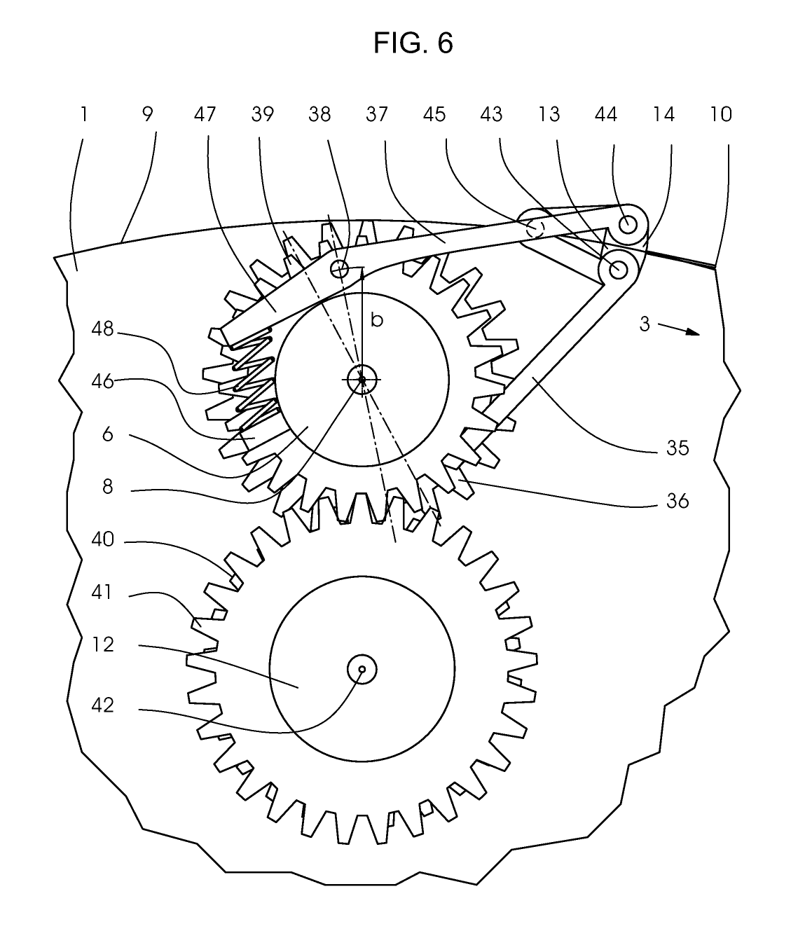

FIGS. 6-8 show a further variant of the gripper system on a turning drum in three different rotary positions of gripper-finger pairs.

A respective first gripper finger 35 of a gripper-finger pair is fastened on a pinion 36, which is disposed in a rotatable manner on a gripper shaft 6. A respective second gripper finger 37 is retained on a pinion 39 at a rotary articulation or joint 38, and this pinion is likewise disposed in a rotatable manner on the gripper shaft 6. The axis of rotation of the rotary articulation or joint 38 is spaced apart by a distance b from, and parallel to, the pivot axis 8 of the gripper shaft 6. The pinions 36, 39 engage with pinions 40, 41 on a drive shaft 12 mounted on the drum body 1. The pinions 40, 41, which are seated in a rotationally fixed manner on the drive shaft 12, can be pivoted about an axis 42 located parallel to the axis 8. The gearwheel pairings of the pinions 36, 40 and 39, 41 have different transmission ratios. Finger tips 13, 14 are retained at the ends of the gripper fingers 35, 37 at rotary articulations or joints 43, 44. The finger tips 13, 14 are connected to one another in each case at a rotary articulation or joint 45. The axes of the rotary articulations or joints 43, 44, 45 are located parallel to the axis 8. A radial support 46 is formed on the gripper shaft 6, a lever arm 47 is formed on the gripper finger 37 and a compression spring 48 is disposed therebetween. When the gripper fingers 35, 37 are opened and closed, the gripper finger 37 is pivoted about the rotary articulation or joint 38, with the compression spring 48 compensating for an offset between the support 46 and the lever 47.

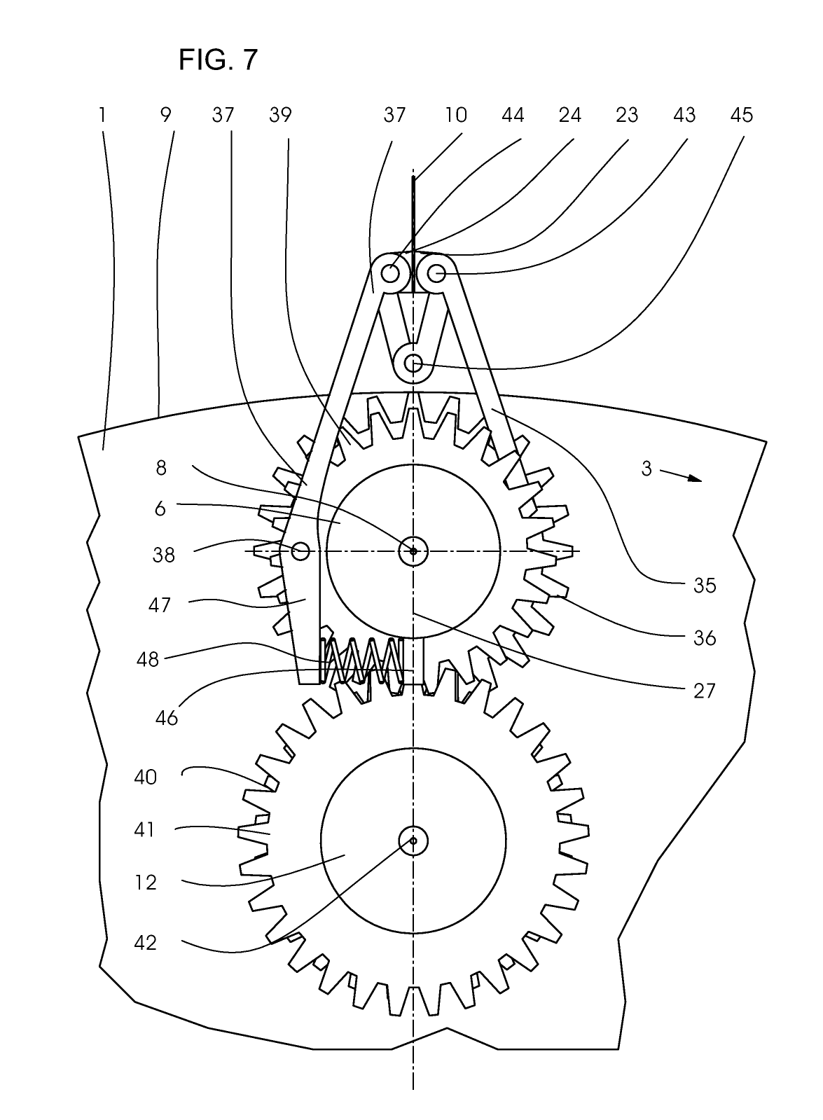

FIG. 6 shows the gripper fingers 35, 37 and the finger tips 13, 14 as the trailing edge of the sheet 10 has been received from an upstream storage drum. When the sheet 10 is conveyed from the storage drum to a downstream impression cylinder, the gripper fingers 35, 37 and the finger tips 13, 14 reach a straightened-out or elongated position, which is illustrated in FIG. 7. In the straightened-out position, the gripper fingers 35, 37 and the gripping surfaces of the finger tips 13, 14 are located symmetrically in relation to a radial line 27 of the drum body 1, and the direction in which the compression spring 48 acts is tangential to the circumferential direction of the turning drum.

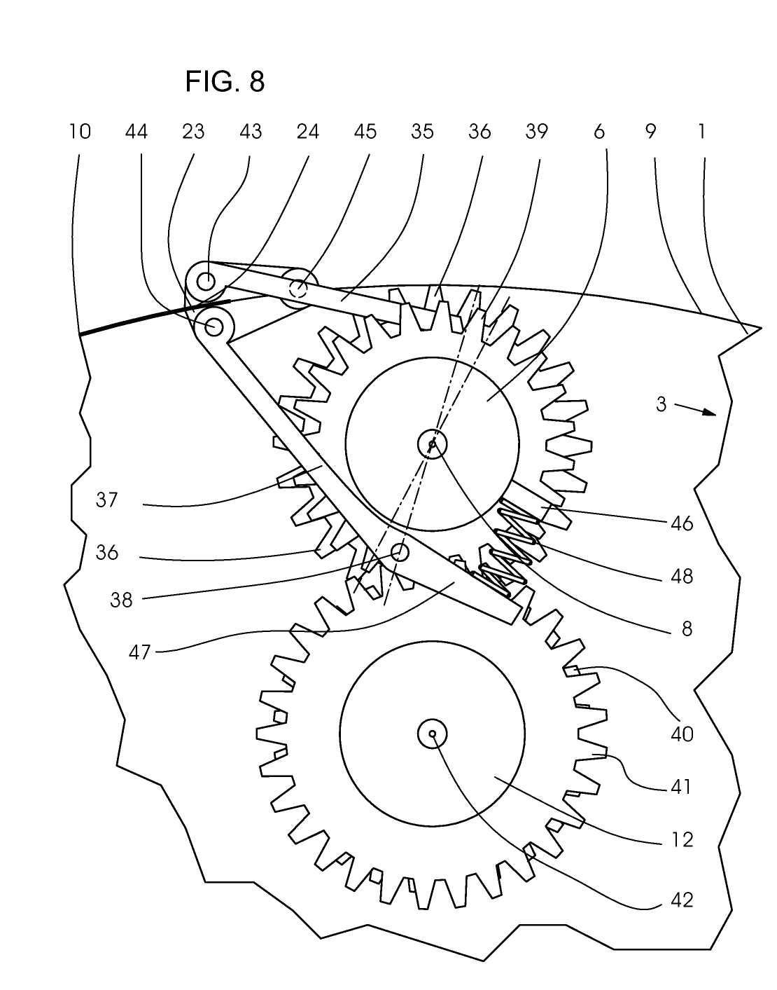

FIG. 8 shows the gripper fingers 35, 37 and the finger tips 13, 14 during transfer to the downstream impression cylinder. Pivoting of the gripper fingers 35, 37 is initiated by virtue of the drive shaft 12 being rotated during a revolution of the drum body 1. The drive shaft 12 can be rotated by a cam gear mechanism. As the gripper fingers 35, 37 are pivoted about the axis 8, the transmission ratios between the pinions 36, 40 and 39,41 causes the finger tips 13, 14 to be pivoted relative to the gripper fingers 35, 37, in which case the gripping surfaces of the finger tips 13, 14 are oriented substantially in the sheet-running direction. While the finger tips 13, 14 are pivoted relative to the gripper fingers 35, 37, the ends of the gripper fingers 35, 37 are displaced relative to one another perpendicularly to the axis 8.

1. A gripper for conveying a sheet through a printing technology machine, the gripper comprising:
two gripper fingers disposed on a revolving body;
finger tips each being disposed at an end of a respective one of said gripper fingers and each having a respective gripping surface;
a device for cyclically pivoting said gripper fingers about an axis;
a device for cyclically opening and closing said gripper fingers; and
rotary joints, said finger tips on said gripper fingers each being disposed at a respective one of said rotary joints.

2. The gripper according to claim 1, wherein said finger tips are pivotable jointly about an axis spaced apart from, and parallel to, said pivot axis of said gripper fingers.

3. The gripper according to claim 2, wherein a pivoting movement of said finger tips precedes a pivoting movement of said gripper fingers, during a cycle.

4. The gripper according to claim 1, which further comprises coupling devices of a linkage mechanism each driving a respective one of said finger tips.

5. The gripper according to claim 1, which further comprises a crank being mounted for pivoting about said pivot axis of said gripper fingers, said finger tips being articulated on said crank.

6. The gripper according to claim 5, which further comprises a spring for opening said finger tips.

7. The gripper according to claim 1, wherein said gripper fingers are displaceable relative to one another perpendicularly to said pivot axis.

8. The gripper according to claim 7, which further comprises an axial element being spaced apart at a distance from, and parallel to, said pivot axis of said gripper fingers, one of said gripper fingers being pivotable about said axial element.

9. The gripper according to claim 1, which further comprises mechanism members driving said finger tips, and a toothed gear mechanism, said gripper fingers and said mechanism members being coupled to said toothed gear mechanism.
